(19) United States
(12) Patent Application Publication
(10) Pub. No.: US 2026/0101137 A1
(43) Pub. Date: Apr. 9, 2026

(54) MICROPHONE DEVICE USED WITH ATTACHING TO IMAGE CAPTURING APPARATUS

(71) Applicant: CANON KABUSHIKI KAISHA, Tokyo (JP)

(72) Inventors: TAKUMA ENDO, Kanagawa (JP); HIDEAKI NAGANO, Kanagawa (JP)

(21) Appl. No.: 19/344,854

(22) Filed: Sep. 30, 2025

(30) Foreign Application Priority Data
Oct. 8, 2024 (JP) 2024-176508

(51) Int. Cl. H04R 1/28; H04R 1/02; H04R 1/08

(52) U.S. Cl. CPC H04R 1/2892; H04R 1/028; H04R 1/08; H04R 1/2876; H04R 2499/11

(57) ABSTRACT

A microphone device capable of reducing vibration from a camera. The microphone device includes a microphone main body including a microphone element collecting sound, an attachment portion attached to the camera, and a connecting portion connecting them. The connecting portion includes a shock absorber that mitigates transmission of vibration from the camera to the microphone main body and a cover that houses the shock absorber. The shock absorber includes a first fixed portion fixed to the attachment portion, second fixed portions fixed to the cover, and elastic coupling portions that couple the first fixed portion and the second fixed portions. Each of the coupling portions has a curved portion that has first and second surfaces that face each other on an inner side of the curved portion, are capable of approaching and separating from each other, and are separated in a natural state in which no external force is applied.

### BACKGROUND

### Field of the Technology

The aspect of the embodiments relates to a microphone device used with attaching to an image capturing apparatus.

### Description of the Related Art

An external microphone is known as an external accessory of an image capturing apparatus such as a digital camera. The external microphone is used in an attached state in which the external microphone is attached to an accessory shoe of the image capturing apparatus. When a moving image is capturing in the attached state of the external microphone, for example, vibration due to driving of a lens of the image capturing apparatus, operation vibration due to an operation on the image capturing apparatus, or the like may be transmitted to the external microphone. The external microphone may collect this vibration as noise. For example, Japanese Patent No. 6164415 discloses a microphone device having a damper capable of absorbing vibration generated in a motor for driving a lens of an image capturing apparatus. The damper of the microphone device disclosed in this publication includes an inner ring, an outer ring disposed outside the inner ring, and a plurality of ribs connecting the inner ring and the outer ring. Each rib extends linearly.

However, the damper of the microphone device disclosed in the above publication impairs a vibration absorbing property to the vibration in the direction parallel to the extending direction of the ribs, that is, impairs a vibration reducing performance. In the microphone device described in the above publication, when the extending direction of the ribs matches a direction perpendicular to a diaphragm of a microphone element, the damper may not sufficiently reduce the vibration (noise). Microphone elements are arranged in various directions according to, for example, a type of system such as a stereo system or a monaural system, a directivity setting as acoustic performance, and the like. Therefore, the damper needs to appropriately arrange the ribs in various arrangement directions of the microphone elements, and thus has poor versatility.

### SUMMARY

The present disclosure provides a microphone device capable of reducing vibration from an image capturing apparatus regardless of an arrangement direction of a microphone element with respect to the image capturing apparatus.

Accordingly, an aspect of the embodiments provides a microphone device used with attaching to an image capturing apparatus. The microphone device includes a microphone main body configured to include a microphone element capable of collecting sound, an attachment portion configured to be attached to the image capturing apparatus, and a connecting portion configured to connect the microphone main body and the attachment portion. The connecting portion includes a shock absorber that mitigates transmission of vibration from the image capturing apparatus to the microphone main body and a cover that houses the shock absorber. The shock absorber includes a first fixed portion fixed to the attachment portion, second fixed portions fixed to the cover, and elastic coupling portions that couple the first fixed portion and the second fixed portions. Each of the coupling portions has a curved portion that is curved at a middle position between the first fixed portion and each of the second fixed portions. And the curved portion has a first surface and a second surface that face each other on an inner side of the curved portion, are capable of approaching and separating from each other, and are separated from each other in a natural state in which no external force is applied.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views illustrating a positional relationship between an image capturing apparatus and a microphone device in a separated state.

FIGS. 2A and 2B are exploded perspective views illustrating the microphone device.

FIG. 3 is a sectional view taken long a line A-A in FIG. 1A.

FIG. 4 is a sectional view taken along a line B-B in FIG. 1B.

FIGS. 5A and 5B are perspective views illustrating a shock damper and an intermediate member.

FIG. 6 is a perspective view illustrating a first variation example of the shock damper applicable in a first embodiment.

FIG. 7 is a perspective view illustrating a second variation example of the shock damper applicable in the first embodiment.

FIG. 8 is a perspective view illustrating a shock damper in a second embodiment.

FIG. 9 is a perspective view illustrating the shock damper in the second embodiment.

FIGS. 10A and 10B are a perspective view and a sectional view illustrating a shock damper in a third embodiment.

FIG. 11 is a perspective view illustrating a variation example of a shock damper applicable to the first, second, and third embodiments.

### DESCRIPTION OF THE EMBODIMENTS

Hereinafter, embodiments of the present disclosure will be described in detail with reference to the drawings. However, configurations described in the following embodiments are merely examples, and the scope of the present disclosure is not limited by the configurations described in the embodiments. For example, each unit constituting the present disclosure can be replaced with any configuration capable of exhibiting the same function. In addition, an arbitrary constituent may be added. Any two or more configurations (features) of the embodiments can be combined.

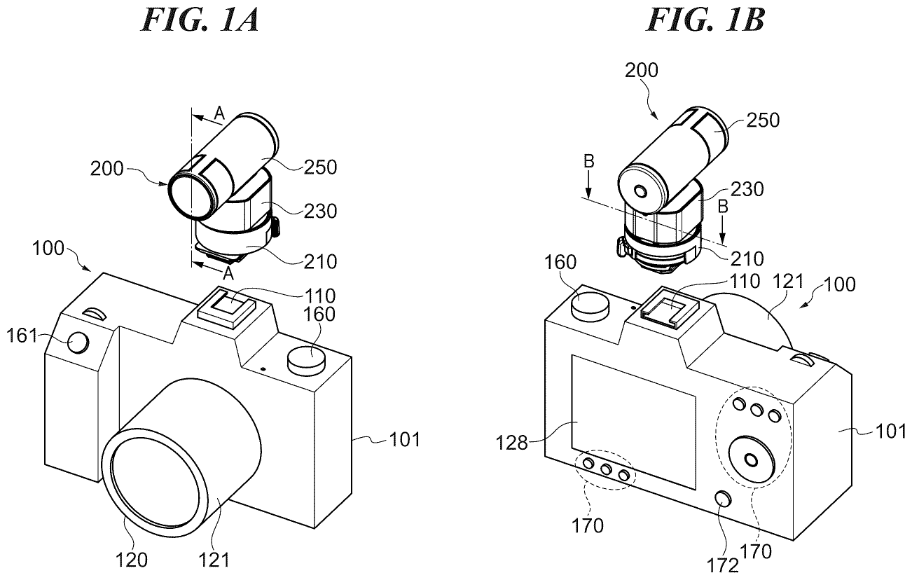

Hereinafter, a first embodiment will be described with reference to FIG. 1A to FIG. 7. FIGS. 1A and 1B are perspective views illustrating a positional relationship between an image capturing apparatus and a microphone device in a separated state. FIG. 1A is a front perspective view. FIG. 1B is a rear perspective view. Hereinafter, for convenience of description, an upper side in FIG. 1A is referred to as “up (or upper)” and a lower side is referred to as “down (or lower)” (the same applies to FIGS. 1B, 2A, 3, and 5A to 11). As illustrated in FIG. 1A, a digital camera 100, which is the image capturing apparatus, includes a camera main body 101, an accessory shoe 110, a mode changeover switch 160, a shutter button 161, and a lens unit 120. As shown in FIG. 1B, the digital camera 100 includes a display unit 128, an operation unit 170, and a power switch 172. A microphone device (hereinafter simply referred to as “microphone”) 200 is detachably attached to the digital camera 100. The microphone 200 is used in an attached state in which the microphone 200 is attached to the digital camera 100. The microphone 200 includes an attachment leg (an attachment portion) 210, a connecting portion (a body portion) 230, and a microphone main body 250.

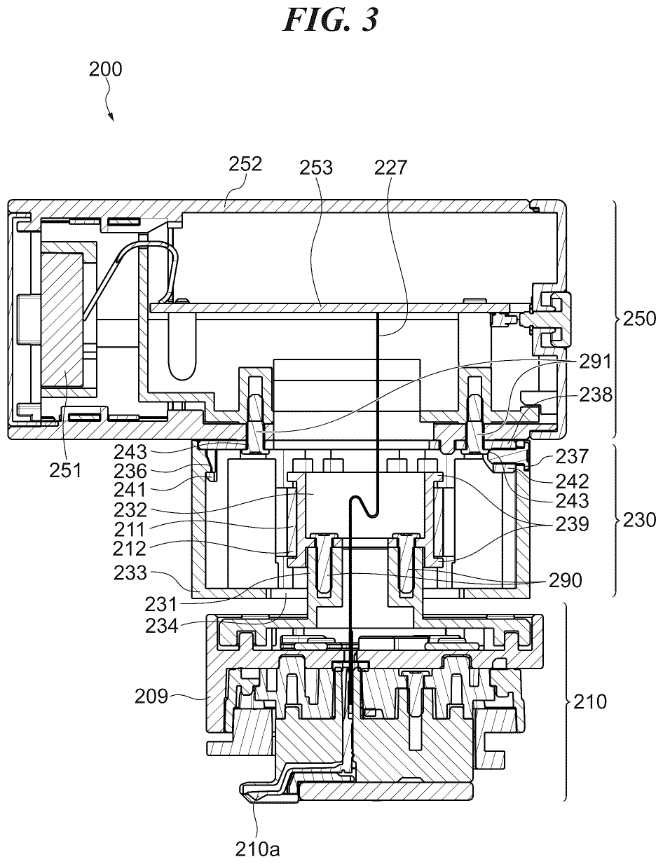

The camera main body 101 has an image sensor (not shown in FIGS. 1A and 1B) constituted by a CCD, a CMOS, or the like. The accessory shoe 110 is disposed near a center of an upper surface of the camera main body 101. An external accessory such as the microphone 200 is detachably connected (attached) to the accessory shoe 110. The accessory shoe 110 is provided with an electrical contact (not shown) that is electrically connected to an electrical contact 210a (FIG. 3) provided in the attachment leg 210 of the microphone 200. The mode changeover switch 160 is disposed at an end portion of the upper surface of the camera main body 101. The mode changeover switch 160 is used to change a mode among various modes including a moving image capturing mode. The shutter button 161 is disposed at an end portion of the upper surface of the camera main body 101 on the side opposite to the mode changeover switch 160. The shutter button 161 is used to issue an image capturing instruction. The lens unit 120 is detachably attached to the front surface of the camera main body 101. The lens apparatus 120 includes a lens barrel 121 that houses lens groups (not shown) for zooming, focusing, image stabilization, and the like. The lens barrel 121 also houses a motor for driving the lens groups. The display unit 128, the operation unit 170, and the power switch 172 are disposed on a rear surface of the camera main body 101. The display unit 128 displays an image and various pieces of information. The operation unit 170 is configured by operation members such as various switches, buttons, and dials. The operation unit 170 receives various operations including a moving image capturing start operation from a user who is using the digital camera 100. The power switch 172 is used to switch the power of the camera main body 101 between ON and OFF.

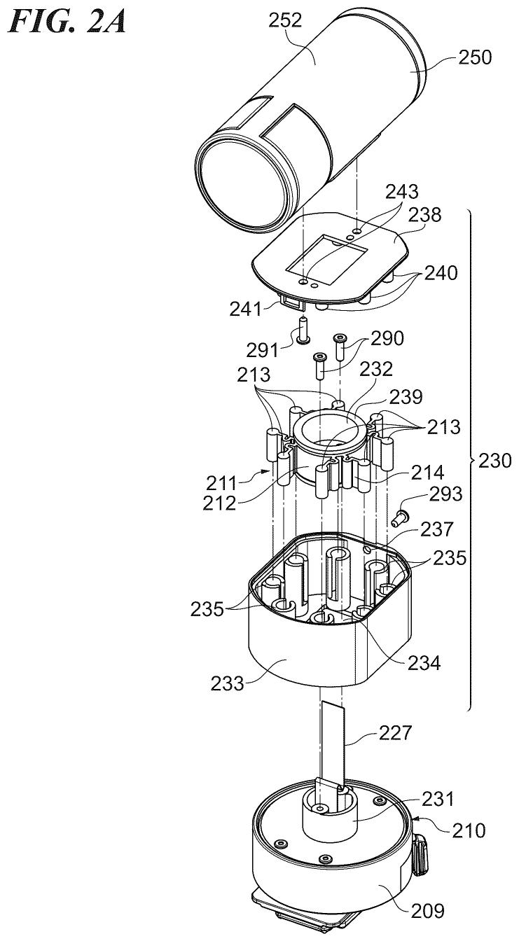

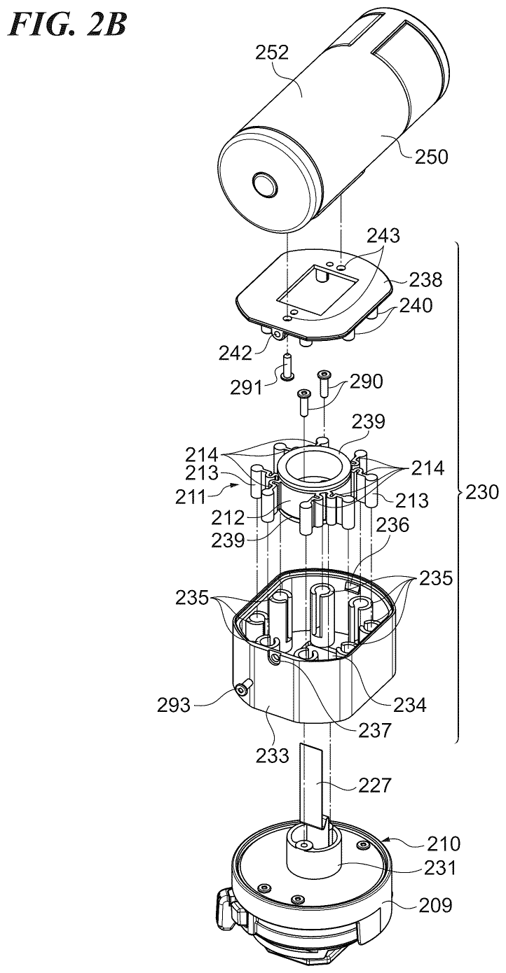

FIGS. 2A and 2B are exploded perspective views illustrating the microphone. FIG. 2A is a front perspective view. FIG. 2B is a rear perspective view. FIG. 3 is a sectional view taken along a line A-A in FIG. 1A. As described above, the microphone 200 includes the attachment leg 210, the body portion 230, and the microphone main body 250, which are arranged in this order from the bottom. The microphone main body 250 is capable of collecting external sound. The attachment leg 210 is detachably attached to the accessory shoe 110 of the digital camera 100. The body portion 230 connects the microphone main body 250 and the attachment leg 210. As illustrated in FIGS. 2A, 2B, and 3, the microphone main body 250 includes a microphone element 251, a control board 253, and a cover 252. The microphone element 251 can collect sound and output the sound as a sound signal. Although the single microphone element 251 is arranged in the present embodiment, two or more microphone elements can be arranged. The microphone element 251 is electrically connected to the control board 253. The sound signal output from the microphone element 251 is subjected to a predetermined process such as a sound synthesis process in the control board 253, and then is transmitted as an electric signal to the digital camera 100 via a flexible board 227 of the attachment leg 210. The cover 252 is a cylindrical member in which the microphone element 251 and the control board 253 are housed. The attachment leg 210 is inserted into the accessory shoe 110 of the digital camera 100 in a predetermined direction (a direction from the back surface to the front surface of the digital camera 100 in the present embodiment). As a result, the microphone 200 is attached to the digital camera 100.

As illustrated in FIGS. 2A, 2B, and 3, the attachment leg 210 includes an attachment leg body 209 and the flexible board 227. The attachment leg body 209 has a disk shape. A body connection portion 231 protruding upward in a cylindrical shape is formed at the center of the attachment leg body 209. The body connection portion 231 is connected to the body portion 230. The attachment leg body 209 supports the flexible board 227. The flexible board 227 is electrically connected to the control board 253 of the microphone main body 250.

As illustrated in FIGS. 2A, 2B, and 3, the body portion 230 includes a shock damper (a shock absorber) 211, an intermediate member 232, a middle case (a cover) 233, and a top case 238. The shock damper 211 is a shock absorber that mitigates transmission of vibration from the digital camera 100 to the microphone main body 250 when the vibration occurs in the digital camera 100, that is, an absorber that absorbs the vibration from the digital camera 100. The vibration generated in the digital camera 100 includes, for example, vibration generated in a motor for driving the lens groups. Although the vibration may be collected as noise by the microphone main body 250, the shock damper 211 can prevent the sound collection. The shock damper 211 is made from elastic material. Such material is not particularly limited, and for example, various rubber materials, such as fluororubber, and in addition, gel, and a porous body, can be used.

The shock damper 211 includes a first fixed portion 212, second fixed portions 213, and arm portions 214. The first fixed portion 212 is fixed to the attachment leg 210. The first fixed portion 212 has a cylindrical shape (a ring shape). The intermediate member 232 having a cylindrical shape is inserted, that is, fitted inside the first fixed portion 212. The intermediate member 232 has a lower portion fixed to the body connection portion 231 of the attachment leg 210 with screws 290. Flanges 239 having an enlarged outer diameter are provided at the upper end portion and the lower end portion of the intermediate member 232, respectively. This prevents the intermediate member 232 from coming off the first fixed portion 212. The first fixed portion 212 is fixed to the attachment leg 210 via the intermediate member 232.

On the outer peripheral side of the first fixed portion 212, a plurality of the second fixed portions 213 are arranged at equal intervals along the circumferential direction. Although the number of the second fixed portions 213 is eight in the present embodiment, this is not limited. For example, the number may be one to seven, or nine or more. Each of the second fixed portions 213 is fixed to the middle case 233. Each of the second fixed portions 213 has a cylindrical shape (a pillar shape) and is arranged so that its central axis is parallel to a central axis of the first fixed portion 212. The entire length (length along the central axis direction) of each of the second fixed portions 213 is equal to the entire length of the first fixed portion 212. A diameter of each of the second fixed portions 213 is smaller than inside and outside diameters of the first fixed portion 212.

The arm portion 214 is a coupling portion that couples the first fixed portion 212 and each of the second fixed portions 213. The height of the arm portion 214 (the length along the central axis direction) is equal to the entire length of the first fixed portion 212. The shock damper 211 is made of a material having elasticity as described above, and each of the arm portions 214 mainly serves to alleviate vibration from the digital camera 100 to the microphone main body 250. Note that, although depending on the arrangement positions of the second fixed portions 213, the arm portions 214 are preferably arranged along at least one of the optical axis direction of the digital camera 100 and the width direction of the digital camera 100. This enables to at least exhibit a vibration mitigation function of the arm portions 214. The shock damper 211 may be entirely made from the elastic material, but it is enough that at least the arm portions 214 are made from the elastic material. Although the shock damper 211 is formed by integrally forming the first fixed portion 212, the second fixed portions 213, and the arm portions 214 in the present embodiment, this is not limited. For example, the shock damper 211 may be configured such that the first fixed portion 212, the second fixed portions 213, and the arm portions 214 are formed as separate bodies, and the separate bodies are connected to each other.

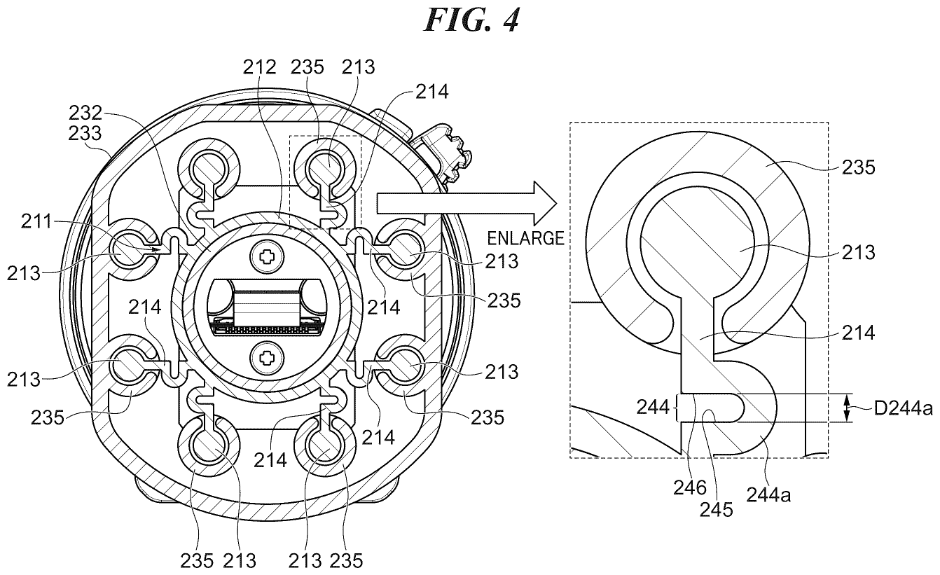

The middle case 233 has a tubular shape and houses the shock damper 211 therein. The middle case 233 has an opening 234 at the bottom hereof, through which the body connection portion 231 of the attachment leg 210 is inserted to prevent interference with the body connection portion 231. Further, damper connecting portions (cover-side fixed portions) 235 for fixing the second fixed portions 213 are provided on the inner peripheral portion of the middle case 233. The damper connecting portions 235 have cylindrical shapes into which the second fixed portions 213 can be respectively inserted in a loosely fitted state, that is, with play (a gap) (see FIG. 4). As a result, the second fixed portions 213 are fixed to the middle case 233. Further, the inner peripheral portion of the middle case 233 is provided with a claw 236 and a hole 237 at positions facing each other.

The top case 238 covers the middle case 233 from above. A plurality of ribs 240 protruding downward are formed on the lower surface of the top case 238. The ribs 240 prevent the second fixed portions 213 of the shock damper 211 from coming off upward from the damper connecting portions 235 of the middle case 233. Further, a recess 241 that engages with the claw 236 of the middle case 233 and a screw hole 242 into which a screw 293 inserted through the hole 237 of the middle case 233 is screwed are provided on the lower surface of the top case 238. The top case 238 has a plurality of through holes 243 penetrating in the up-down direction. A screw 291 screwed with the microphone main body 250 is inserted into each of the through holes 243. Accordingly, the top case 238 is fixed to the microphone main body 250. The microphone main body 250 and the attachment leg 210 are connected via the body portion 230 having such a configuration.

FIG. 4 is a sectional view taken along a line B-B in FIG. 1B. Since the configurations of the respective arm portions 214 are the same, the configuration of one arm portion 214 will be described as a representative example. As illustrated in FIG. 4, the arm portion 214 has a curved portion 244a that is curved at a middle position between the first fixed portion 212 and the second fixed portion 213. The curved portion 244a has a first inner surface (a first surface) 245 and a second inner surface (a second surface) 246 that face each other on the inner side of the curved portion. The first inner surface 245 is located on the side of the first fixed portion 212, and the second inner surface 246 is located on the side of the second fixed portion 213. The first inner surface 245 and the second inner surface 246 are capable of approaching and separating from each other according to the use state of the digital camera 100, that is, the posture (direction) of the microphone 200. The first inner surface 245 and the second inner surface 246 are spaced apart from each other in a natural state in which no external force is applied, and a gap 244 is formed between the first inner surface 245 and the second inner surface 246. Note that the portions on both sides of the arm portion 214 across the curved portion 244a are formed in straight lines parallel to each other in the natural state. In addition, although the arm portions 214 adjacent to each other among the plurality of arm portions 214 are different in the direction of the curve, that is, different in the direction of the curved convex in the present embodiment, this is not limited, and they may be identical in the direction of the curve. The curved portion 244a having such a configuration can release vibration through the gap 244 when the vibration from the digital camera 100 is transmitted to the attachment leg 210 of the microphone 200 in a direction parallel to the extending direction of the arm portion 214. This prevents an increase in rigidity, that is, a decrease in the vibration reduction effect, due to strutting of the arm portion 214. Therefore, it is possible to reduce the vibration from the digital camera 100 regardless of the arrangement direction of the microphone 200 (microphone element 251) with respect to the digital camera 100.

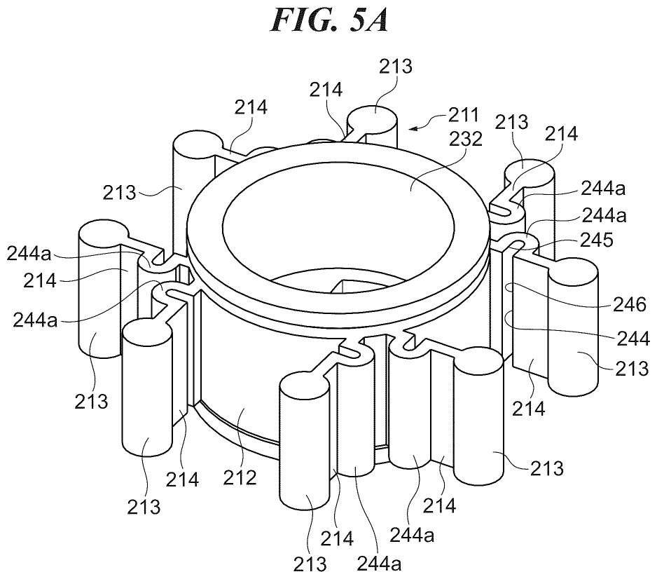

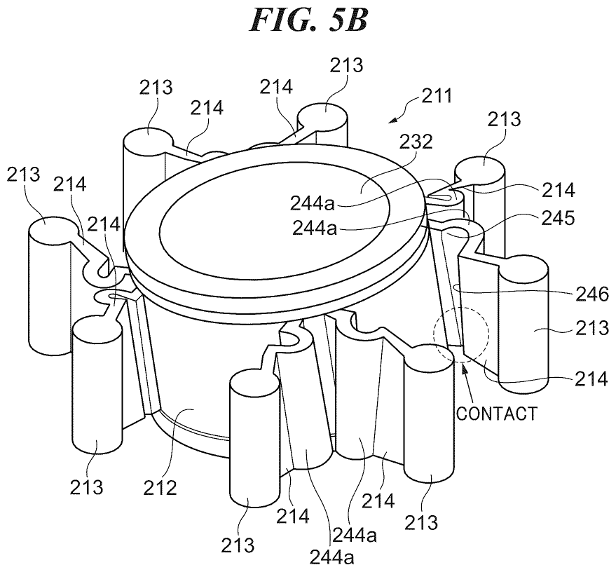

As described above, the shock damper 211 has elasticity. Therefore, the body portion 230 and the microphone main body 250 of the microphone 200 attached to the digital camera 100 may be inclined with respect to the accessory shoe 110 depending on the use state of the digital camera 100. This will be described with reference to FIGS. 5A and 5B. FIGS. 5A and 5B are perspective views illustrating the shock damper and the intermediate member. FIG. 5A is a perspective view in the natural state. FIG. 5B is a perspective view in a state where inclination occurs. In the state shown in FIG. 5A, the gap 244 is formed between the first inner surface 245 and the second inner surface 246 of each of the arm portions 214 of the shock damper 211. As the generated inclination increases, the first inner surface 245 and the second inner surface 246 approach each other from the upper end side or the lower end side. Finally, the first inner surface 245 and the second inner surface 246 come into contact with each other as illustrated in FIG. 5B. In this state, the inclination limit of the body portion 230 and the microphone main body 250 with respect to the accessory shoe 110 is regulated, that is, further inclination is restricted. This prevents the body portion 230 and the microphone main body 250 from being excessively inclined with respect to the accessory shoe 110. A clearance D244a (see FIG. 4) of the gap 244 is preferably set as follows. The clearance D244a is set such that, when the body portion 230 and the microphone main body 250 are inclined, the first inner surface 245 and the second inner surface 246 come into contact with each other before the attachment leg 210 and the body portion 230 or the microphone main body 250 come into direct contact with each other.

In addition, when an image is captured with the digital camera 100 to which the microphone 200 is attached, an object may move relatively largely or a user may ride in a vehicle. In addition, when the digital camera 100 to which the microphone 200 is attached is mounted on a vehicle, something may come into contact with or collide with the microphone 200 unintentionally, which occurs a relatively large inertia or impact such as tilting of the shock damper 211. In such a case, when the attachment leg 210 of the microphone 200 comes into contact with the body portion 230 or the microphone main body 250, a vibration reduction effect by the shock damper 211 may not be sufficiently exhibited. As a result, the vibration may be directly transmitted to the microphone main body 250 from a contact portion between the attachment leg 210 and the body portion 230 or the microphone main body 250. However, since the microphone 200 is designed, as described above, so that the first inner surface 245 and the second inner surface 246 are in contact with each other, it is possible to prevent the vibration from being directly transmitted from the contact portion to the microphone main body 250. In a normal image capturing state in which relatively large inertia or impact that inclines the shock damper 211 is not applied, it is preferable that the first inner surface 245 and the second inner surface 246 of the shock damper 211 are sufficiently separated from each other so that the vibration reduction effect can be exhibited to the maximum.

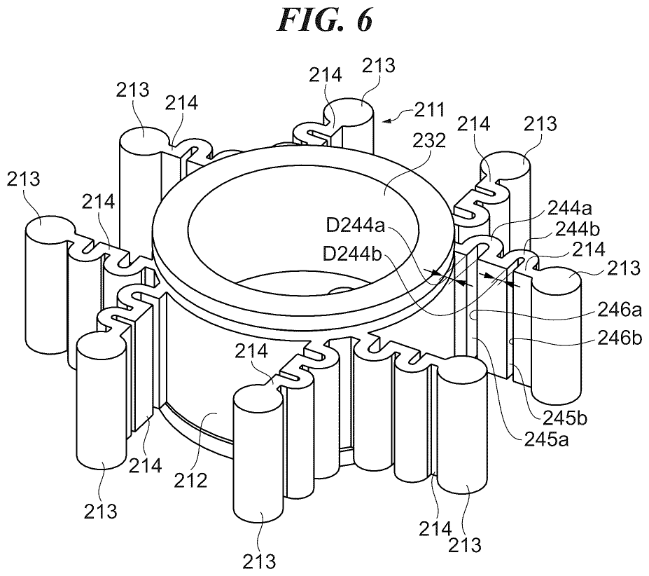

FIG. 6 is a perspective view illustrating a first variation example of the shock damper applicable in the first embodiment. As illustrated in FIG. 6, each of the arm portions 214 has a curved portion 244a formed on the side of the first fixed portion 212 and a curved portion 244b formed on the side of the second fixed portion 213. The curved portion 244a and the curved portion 244b are curved and convex in the same direction. The curved portion 244a has a first inner surface 245a and a second inner surface 246a. The curved portion 244b has a first inner surface 245b and a second inner surface 246b. In addition, a clearance D244a between the first inner surface 245a and the second inner surface 246a of the curved portion 244a in the natural state is preferably different from a clearance D244b between the first inner surface 245b and the second inner surface 246b of the curved portion 244b in the natural state. Specifically, the clearance D244a is preferably longer than the clearance D244b. When the inclination occurs, the first inner surface 245b and the second inner surface 246b of the curved portion 244b first come into contact with each other due to a magnitude correlation between the clearances, and then, when the inclination increases, the first inner surface 245a and the second inner surface 246a of the curved portion 244a come into contact with each other. This enables limitation of inclination ability of the shock damper 211 stepwisely. Although the number of the curved portions formed is two in the present variation example, this is not limited. For example, the number may be three or more.

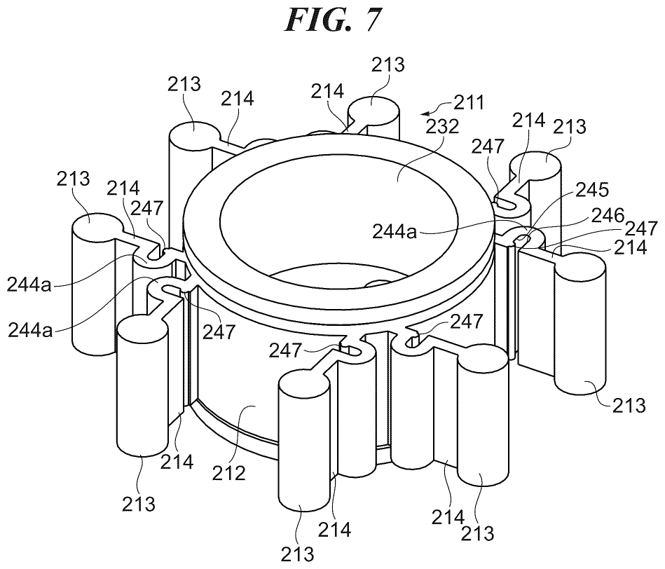

FIG. 7 is a perspective view illustrating a second variation example of the shock damper applicable in the first embodiment. As illustrated in FIG. 7, the first inner surface 245 (one surface) of the first inner surface 245 and the second inner surface 246 is provided with a protrusion 247 that protrudes toward the second inner surface 246 (the other surface). The protrusion 247 is capable of approaching and separating from the second inner surface 246. Accordingly, as the shock damper 211 inclines, the protrusion 247 comes into contact with the second inner surface 246. Such contact can reduce the area of contact as compared with the case where the protrusion 247 is omitted, and thus contributes to the mitigation of the impact at the time of contact. Note that the protrusion 247 is provided on the first inner surface 245, but this is not limited, and may be provided on the second inner surface 246, or may be provided on both the first inner surface 245 and the second inner surface 246.

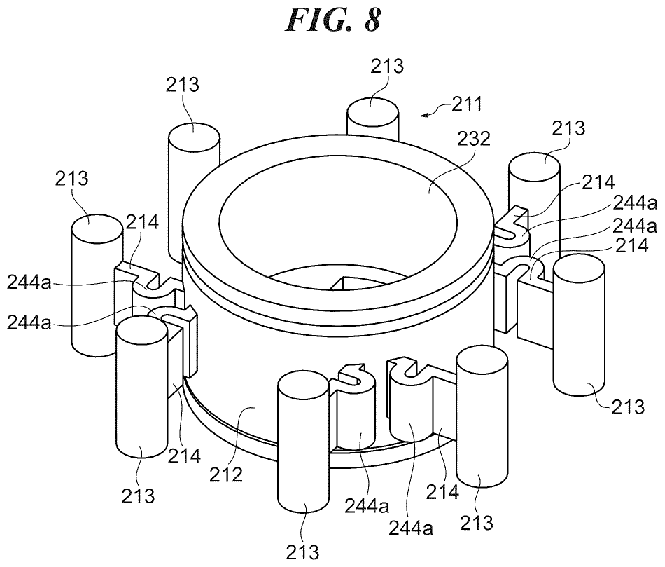

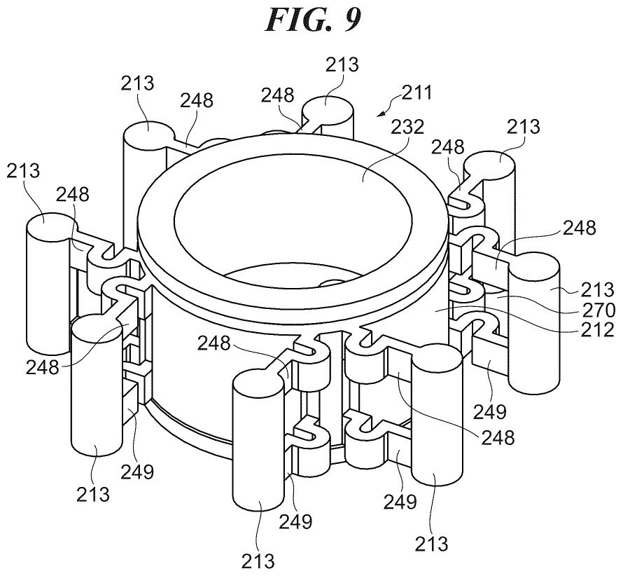

Hereinafter, a second embodiment will be described with reference to FIGS. 8 and 9. Differences from the above-described embodiment will be mainly described, and the description of the same matters will be omitted. FIGS. 8 and 9 are perspective views illustrating shock dampers in the second embodiment, respectively. One of the configurations for improving the vibration reduction effect of the shock damper 211 of the first embodiment is to reduce the rigidity of the shock damper 211. As a configuration to reduce the rigidity of the shock damper 211, the shock damper 211 illustrated in FIG. 8 is designed so that the height of the arm portion 214 is smaller than the entire length of the first fixed portion 212. This reduces the rigidity of the shock damper 211, thereby improving the vibration reduction effect. The shock damper 211 illustrated in FIG. 8 tends to be more likely to incline because of decrease in rigidity. In this case, there is a concern that the microphone 200 may be enlarged due to the securing of the clearance for preventing the contact between the attachment leg 210 and the body portion 230 or the microphone main body 250. In addition, since the shock damper 211 is likely to be inclined, the microphone 200 is shaken back and forth and right and left, for example, in capturing a moving image while walking, and there is a concern that stable sound collection is hindered.

As illustrated in FIG. 9, the shock damper 211 includes a first arm portion 248 and a second arm portion 249 as the arm portions for each of the eight second fixed portions 213. The first arm portion 248 and the second arm portion 249 are disposed in the up-down direction (along the central axis direction of the first fixed portion 212). The first arm portion 248 connects an upper end portion of the first fixed portion 212 and an upper end portion of the second fixed portion 213. The second arm portion 249 connects a lower end portion of the first fixed portion 212 and a lower end portion of the second fixed portion 213. The first arm portion 248 and the second arm portion 249 are spaced apart from each other in the up-down direction, and a gap 270 is formed between the first arm portion 248 and the second arm portion 249. The volume of the portion connecting the first fixed portion 212 and the second fixed portion 213 is reduced by the gap 270, and the rigidity against shear deformation is reduced. Further, a sectional secondary moment around the optical axis (x axis) of the digital camera 100 passing through the central axis of the shock damper 211 or a sectional secondary moment around the axis (z axis) along the width direction of the digital camera 100 are expressed by the following equation (1).

$${I}_{x , z} = {\int }_{- h / 2}^{h / 2} {y}^{2} bdy \qquad ( 1 )$$

$${I}_{x , z} : Sectional secondary moment around x axis or z axis$$

$$h : Hight of arm portion 214 or arm portions 248 and 249$$

$$b : Thickness of arm portion 214 or arm portions 248 and 249$$

As is clear from the equation (1), the longer a distance from the axis to the cross section in the height direction is, the larger the sectional secondary moment is. Accordingly, the shock damper 211 illustrated in FIG. 9 reduces the rigidity of the shock damper 211 in the translation direction to improve the vibration reduction effect, and the sectional secondary moment around the x axis or the z axis is higher than that of the shock damper 211 illustrated in FIG. 8. As a result, the shock damper 211 illustrated in FIG. 9 can reduce the inclination more than the shock damper 211 illustrated in FIG. 8. Note that the shock damper 211 has two arm portions as the arm portions for each of the second fixed portions 213 in the present embodiment, but this is not limited, and may have, for example, three or more arm portions.

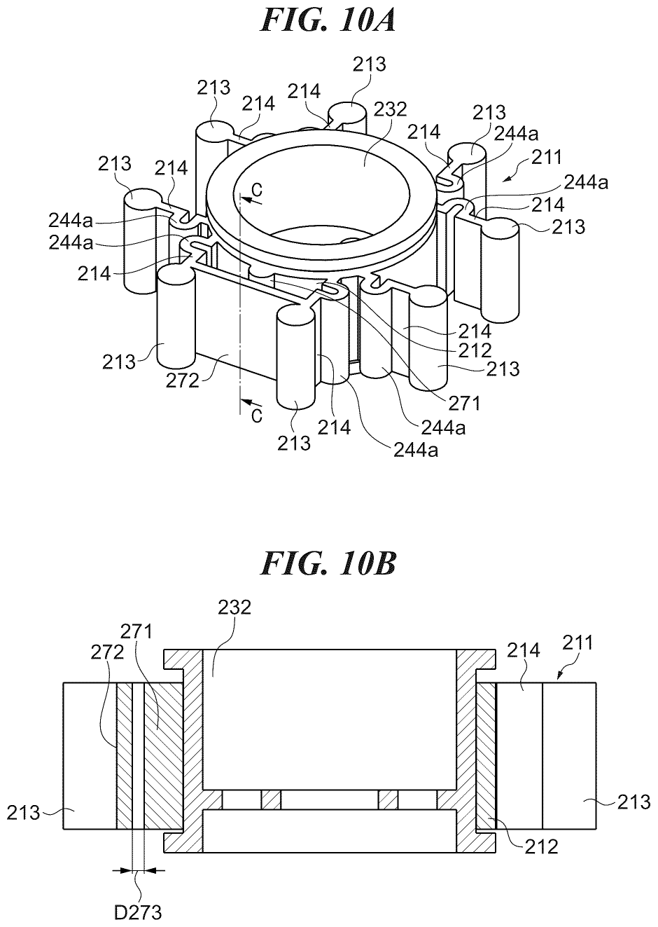

Hereinafter, a third embodiment will be described with reference to FIGS. 10A and 10B. Differences from the above-described embodiments will be mainly described, and description of the same matters will be omitted. FIGS. 10A and 10B are a perspective view and a sectional view illustrating a shock damper in the third embodiment. FIG. 10A is the perspective view. FIG. 10B is the sectional view taken along a line C-C in FIG. 10A. As shown in FIG. 10A, the shock damper 211 includes a plate-shaped portion 272 that is provided between a pair of adjacent second fixed portions 213 among the eight second fixed portions 213. The shock damper 211 includes a protrusion 271 provided on the outer periphery of the first fixed portion 212 and protruding toward the plate-shaped portion 272. The plate-shaped portion 272 and the protrusion 271 are capable of approaching and separating from each other. The plate-shaped portion 272 and the protrusion 271 can restrict the inclination limit of the body portion 230 and the microphone main body 250 with respect to the accessory shoe 110 in a state where the plate-shaped portion 272 and the protrusion 271 are in contact with each other. This prevents the body portion 230 and the microphone main body 250 from being excessively inclined with respect to the accessory shoe 110. A clearance D273 (see FIG. 10B) between the plate-shaped portion 272 and the protrusion 271 is preferably set in the same manner as the clearance D244a.

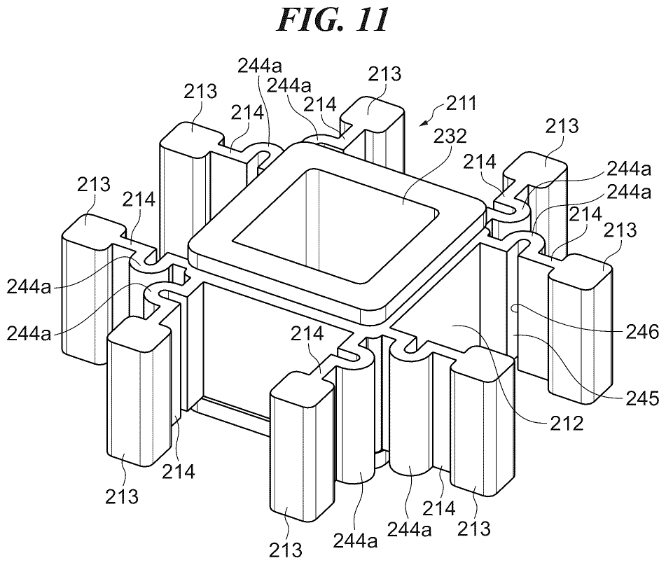

FIG. 11 is a perspective view illustrating a variation example of a shock damper applicable to the first, second, and third embodiments. As illustrated in FIG. 11, the shock damper 211 includes a first fixed portion 212 having a quadrangular ring shape and second fixed portions 213 each of which has a quadrangular prism shape. In this case, an intermediate member 232 also has a quadrangular ring shape.

According to the present disclosure, it is possible to reduce vibration from the image capturing apparatus regardless of the arrangement direction of the microphone element with respect to the image capturing apparatus.

### OTHER EMBODIMENTS

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176508, filed Oct. 8, 2024 which is hereby incorporated by reference herein in its entirety.

What is claimed is:

1. A microphone device used with attaching to an image capturing apparatus, the microphone device comprising:
a microphone main body configured to include a microphone element capable of collecting sound;
an attachment portion configured to be attached to the image capturing apparatus; and
a connecting portion configured to connect the microphone main body and the attachment portion,
wherein the connecting portion includes a shock absorber that mitigates transmission of vibration from the image capturing apparatus to the microphone main body and a cover that houses the shock absorber,
wherein the shock absorber includes a first fixed portion fixed to the attachment portion, at least one second fixed portion fixed to the cover, and elastic coupling portions that couple the first fixed portion and the at least one second fixed portion,
wherein each of the coupling portions has a curved portion that is curved at a middle position between the first fixed portion and the at least one second fixed portion, and
wherein the curved portion has a first surface and a second surface that face each other on an inner side of the curved portion, are capable of approaching and separating from each other, and are separated from each other in a natural state in which no external force is applied.

2. The microphone device according to claim 1, wherein the coupling portions are arranged along at least one of an optical axis direction of the image capturing apparatus and a width direction of the image capturing apparatus.

3. The microphone device according to claim 1, wherein the first surface and the second surface are capable of regulating an inclination limit of the microphone device with respect to the image capturing apparatus in a state where the first surface and the second surface are in contact with each other.

4. The microphone device according to claim 1, wherein at least two of the curved portions are formed in each of the coupling portions,
a clearance between the first surface and the second surface of the curved portion formed on a side of the first fixed portion is different from a clearance between the first surface and the second surface of the curved portion formed on a side of the at least one second fixed portion in the natural state.

5. The microphone device according to claim 4, wherein the clearance between the first surface and the second surface of the curved portion formed on the side of the first fixed portion is longer that the clearance between the first surface and the second surface of the curved portion formed on the side of the at least one second fixed portion in the natural state

6. The microphone device according to claim 1, wherein one of the first surface and the second surface is provided with a protrusion that protrudes toward another surface and is capable of approaching and separating from the other surface.

7. The microphone device according to claim 1, wherein the first fixed portion has a ring shape, and the at least one second fixed portion comprises a plurality of second fixed portions that are disposed on an outer peripheral side of the first fixed portion along a circumferential direction of the first fixed portion.

8. The microphone device according to claim 7, wherein each of the second fixed portions is formed in a pillar shape, and central axes of the second fixed portions are arranged in parallel to a central axis of the first fixed portion in the natural state.

9. The microphone device according to claim 8, wherein each of the second fixed portions has a cylindrical shape,
the cover has cover-side fixed portions to fix the second fixed portions, and
each of the cover-side fixed portions has a cylindrical shape into which each of the second fixed portions can be inserted in a loosely fitted state.

10. The microphone device according to claim 7, wherein the coupling portions are disposed along the central axis direction of the first fixed portion for each of the second fixed portions,
the coupling portions are separated to each other in the central axis direction of the first fixed portion.

11. The microphone device according to claim 7, wherein a plate-shaped portion is provided between the adjacent second fixed portions,
a protrusion that protrudes toward the plate-shaped portion and is capable of approaching and separating from the plate-shaped portion is provided on an outer periphery of the first fixed portion.

12. The microphone device according to claim 11, wherein the plate-shaped portion and the protrusion are capable of regulating an inclination limit of the microphone device with respect to the image capturing apparatus in a state where the the plate-shaped portion and the protrusion are in contact with each other.
